(19) United States
(12) Patent Application Publication
(10) Pub. No.: US 2005/0172595 A1
(43) Pub. Date: Aug. 11, 2005

(54) Pneumatic raisin harvester

(76) Inventors: James R. Wells, Selma, CA (US); J. Dwayne Wells, Selma, CA (US); Paul A. Colliver, Selma, CA (US)

Correspondence Address: Richard A. Ryan, Suite 110, 8497 N. Millbrook Avenue, Fresno, CA, 93720, US

(21) Appl. No.: 11/054,207

(22) Filed: Feb. 8, 2005

Related U.S. Application Data
(60) Provisional application No. 60/543,245, filed on Feb. 9, 2004.

(51) Int. Cl. A01D 34/30

(52) U.S. Cl. 56/13.1

(57) ABSTRACT

A pneumatic raisin harvester for harvesting dried-on-the-vine raisins grown on a trellis system comprising a plurality of support stakes and a trellis wire interconnecting the stakes spaced apart from the vine trunk. The harvester has a support assembly attached to and transported by a tractor or other vehicle. A support arm extends outwardly from the tractor to support a harvesting head having a head enclosure configured to straddle the trellis wire and support stakes. A crop separating mechanism, such as a plurality of beater rods, disposed inside the head enclosure dislodges raisins from the vines. A raisin collecting system transports the raisins to a venturi inlet that is hydraulically connected to a hydraulically powered pneumatic conveying system comprising a blower that discharges pressurized air through one or more air tubes so as to deposit the raisins in one or more raisin bins on a bin trailer towed by the tractor.

### CROSS-REFERENCE TO RELATED APPLICATIONS

This application claims the benefit of U.S. Provisional Application No. 60/543,245 filed Feb. 9, 2004.

### BACKGROUND OF THE INVENTION

A. Field of the Invention

The field of the present invention relates generally to mechanical harvesters for use in harvesting grapes, raisins and similarly situated crops. More specifically, the field of the present invention relates generally to the mechanical harvesting of dried on the vine raisins. Even more particularly, this invention relates to the mechanical collecting of dried on the vine raisins and pneumatic conveying of the raisins into bins.

B. Background

As is well known, the conventional methods of harvesting grapes, raisins and other vine crops is typically a very labor intensive process requiring a significant number of laborers to separate the crop from the vines. Such methods generally require labor crews to walk through the vineyard and individually cut clusters of fruit from the vine. With regard to harvesting raisins, the economic production of raisins is subject to and substantially driven by such factors as labor availability, ever increasing labor and material costs, and unpredictable weather. The conventional method of growing raisins is to grow grape vines in separate parallel rows utilizing a trellis system that runs along the row producing rows of vines approximately four to six feet high. The method of harvesting raisins predominately in use today utilizes manual labor to cut the grapes from the vines, remove the grapes from the stems and then place the bunches of grapes on paper sheets, commonly referred to as trays, to dry in the sun. Periodically, laborers turn the grapes on the trays to obtain more thorough drying. Once dried, the paper trays are folded and rolled, with the raisins disposed inside, and collected. The raisins are then separated from the trays, placed in raisin bins and delivered to packing houses for final processing. The discarded paper trays are typically burned in the field, which is known to create environmental concerns with regard to air and other pollution. The amount of time necessary for in-the-field dehydration of the grapes into raisins is dependent upon various environmental factors, including temperature and humidity. In the Central Valley area of California, for instance, this typically requires the fruit to lie in the sun for approximately three weeks. The entire raisin harvesting/drying process is at the mercy of the weather. If a rain storm occurs while the raisins are lying on the paper trays the crop can be completely lost or at least greatly compromised by the onset of mold. In addition, rain splashes sand and dirt onto the raisin which becomes embedded in the wrinkles when dried, creating problems and additional cost for processing.

Various procedures and mechanisms have been developed to improve the efficiency of raisin production and to reduce the costs associated with harvesting raisins. Some of these mechanisms are addressed to machines capable of removing the green grapes from the vines and placing them on the paper trays for drying. Some, such as U.S. Pat. No. 4,221,665 to Decker, are for raisin harvesting apparatuses configured for picking up raisin paper trays and depositing the raisins into bins. One mechanical method of harvesting/drying raisins in use requires special soil preparation, namely that the row must be free of weeds and terraced smooth. The canes are hand cut about ten days prior to harvest so that the grape can be removed from the cluster with the stem attached. The grapes are removed from the vines with a mechanical vibration system and simultaneously placed on a continuous tray. This procedure requires a four man crew. After the raisins are dried, they are mechanically removed from the tray and deposited into a bin trailer in the adjacent row using a mechanical conveyor system. This process requires two machines and two operators. Although this method of harvesting raisins has certain advantages over the labor intensive previous methods, it still has a number of limitations, namely: (1) the raisins are still subject to rain damage while laying on the trays; (2) the required soil terracing results in more fine sand and loose dirt being available to blow onto and collect on the raisins; (3) the need for a four man crew and costly special machinery to harvest the raisins; and (4) the complicated machinery used in this system typically requires excessive maintenance.

To reduce the cost associated with harvesting raisins, growers have developed various new methods that are more suitable for reducing labor costs. One relatively recent improvement to growing raisins is referred to as the dried-on-the-vine (“DOV”) method. The DOV method of growing raisins leaves the grape clusters on the vines during the drying process, as opposed to laying them on paper trays for the dried-on-the-ground method. In this method, labor crews go through the vineyard and cut the fruiting canes so that the grapes on those canes will dry to produce raisins. The dried raisins are then removed and collected directly from the vines. An early example of a DOV method is commonly known as the Southside or Sun Maid system after its originator, Sun Maid, which is described in U.S. Pat. No. 5,411,561 to Conley. The Southside System utilizes a modified conventional trellis structure that trains the canes into a divided canopy with the fruiting canes primarily on one side (the south side) of the rows and renewal canes on the opposite side. This system requires special trellising stakes at 45 degree angles to support the wires to which the fruit canes are tied. Next year's fruiting canes, which are the present year's renewal canes, are tied to a trellis wire on top of the trellis system. The grapes are dried on the special trellis for a period of approximately six weeks. Harvesting the raisins requires a specially designed cutter that cuts the fruit bearing canes from the vines. Once dried the raisins are mechanically harvested using a specially designed and dedicated machine, such as the harvester described in U.S. Pat. No. 5,557,883 to Walker, that uses rotating and/or oscillating fiberglass rods to dislodge the raisin onto a vibrating tray which conveys the raisins to belt conveyors and then into bins. U.S. Pat. No. 5,355,667 to Scott, U.S. Pat. No. 6,009,696 to Walker and U.S. Pat. No. 6,012,276 to Walker also generally disclose harvesting machines that are either pulled or driven between the rows of vines with a plurality of rods or paddles extending from the side of the harvester such that the rods or paddles engage the plants to dislodge the raisins therefrom. The dislodged raisins are collected on a conveyance system and then, typically, transported up and over the vines into a truck or bin trailer pulled by a tractor in the adjacent row. The Southside system of growing and harvesting raisins also has significant limitations, namely the high initial cost of installing the specially configured trellis system, the initial high cost of the mechanical equipment necessary to effectively utilize the system and the need for a six man crew to harvest the raisins.

Another DOV system is described in U.S. Pat. No. 5,144,768 to Hiyama, et al. In the Hiyama system, a modified trellis system is utilized to horizontally segregate the canes that will produce fruit in one year from the canes which are to produce fruit in the following year. Control wires are used to move the renewal canes from the current year's growing row to the next year's growing row. U.S. Pat. No. 6,578,318 to Clark describes a method of growing raisins which vertically separates the fruiting zone from the renewal zone by placing the fruiting canes in an upper zone apart from the renewal canes in the lower zone. This patent also describes a double tunnel harvesting apparatus that allows the upper fruiting zone to be harvested while protecting the lower renewal zone from damage.

Some newer methods for growing raisins utilize an overhead trellis system that allows the vines to be trained such that the canes grow over the trellis wires disposed between rows of upright posts that are placed along the rows of vines. One method of growing grapes and raisins on an overhead trellis system is disclosed in U.S. Pat. No. 5,711,109 to Pitts. In the Pitts method, the vine plants are separated to form four cordons and trained such that two pairs of cordons grow along parallel courses but opposite each other. Canes produced by the cordons grow substantially perpendicular to the cordons toward the canes produced by an adjacent row of vines over an overhead trellis structure. This method utilizes an alternate bearing system wherein during each growing season one row is a fruiting row and the adjacent row is a renewal row. During the following season, the rows are reversed. This method of growing grapes and raisins is referred to as the quadrilateral, alternate bearing method and has been found to substantially increase production of grapes and raisins. In another method of growing raisins on an overhead trellis system was developed by Lee Simpson of Madera, Calif. In this system, the canes grow from the head of the vine and are placed across the wires such that the crop will grow in a generally vertical downward direction from the canes between the rows. This method also utilizes the alternate bearing system.

Mechanical harvesters for harvesting grapes or raisins grown on an overhead trellis system are also known. For instance, U.S. Pat. No. 5,423,166 to Scott is directed to a grape and raisin harvester in the form of a trailer that utilizes a series of spinning rods fashioned into a rotating rolling brush that knocks the grapes or raisins off the plants and into one or more boxes located on the trailer platform. The harvester is pulled along the row by a tractor. The rotating rolling brush, referred to as a shaker head, is raised or lowered by the use of hydraulic cylinders linked to the shaker head. Another apparatus for mechanically harvesting grapes or raisins developed by Mr. Lee Simpson in Madera County, Calif., is a self-propelled harvester that utilizes a rotating tubular mechanism to knock off the raisin clusters below the trellis wires into a hopper and a conveyor system to transport the raisins backward to deposit them into a bin attached to forklift-type tines on the back of the harvester. A hand crew follows behind to remove the raisin clusters above the trellis wires or otherwise missed by the rotating tube. After the bin is filled, the harvester is stopped, backs up and then drops the bin on the ground. The harvester then moves forward to space itself from the dropped bin so that an empty bin can be manually moved over behind the harvester so that it may be picked up by the tines on the back of the harvester. A forklift or other apparatus then picks up the full bin and removes it from the row. This system requires the empty bins to either be previously placed, hopefully strategically, along the row or the row adjacent to that being harvested or delivered to the harvester's stop point by a trailer or tractor. Failure to properly place the empty bins requires additional handling of the bins and the labor associated therewith. Even with strategically placed empty bins, this harvester and method of harvesting still requires a significant amount of labor and results in a certain amount of wasted (i.e., non-harvesting) time for dropping off the bins, moving empty bins and retrieving the full bins. U.S. Pat. No. 6,557,335 to Amaro, et al. describes a harvester having a frame system configured generally in an upside down u-shape with a top portion having crop separating mechanisms to engage the overhead vines and separate the raisins therefrom. The frame is sized and configured to allow crop bins or gondolas to pass under the top portion and through the harvester so that the harvester can continuously harvest an entire row of crops

While the aforementioned DOV raisin growing systems are generally known to provide benefits over conventional raisin growing methods, they typically require significant investment in trellis structures and/or harvesting equipment. What is needed, therefore, is a less expensive and less labor intensive apparatus for harvesting DOV raisins than is presently available. The preferred harvester should be adaptable for effectively removing DOV raisins and conveying the harvested raisins into conventional raisin bins. In addition, the preferred harvester should be adaptable for use with commonly available farm vehicles, such as tractors and the like, so as to not require a high initial investment in trellis structures and harvesting equipment.

### SUMMARY OF THE INVENTION

The pneumatic raisin harvester of the present invention provides the benefits and solves the problems identified above. That is to say, the present invention discloses a raisin harvester for DOV raisins that is adaptable to being attached to a tractor and pulled through the field so as to effectively remove raisins from the vines and deposit them into a bin. The raisin harvester includes hydraulic-powered harvesting head with beaters disposed therein to dislodge the dried raisins from specially trellised vines and a funnel-shaped raisin collection trough which fees a hydraulic-powered pneumatic conveying and piping system. As a result of the use of the harvester and method of harvesting of the present invention, the grower can more efficiently and effectively harvest raisins, while reducing his or her dependance on manual labor, thereby substantially reducing the cost of such harvesting.

In one general aspect of the present invention, the pneumatic raisin harvester of the present invention is configured for attachment to a field vehicle, such as a tractor, suitable for towing a bin trailer that carries one or more raisin bins thereon so as to harvest DOV raisins from a plurality of vines supported on a trellis wire interconnecting a plurality of support stakes. To effectively utilize the harvester of the present invention, the vines are trained such that the fruiting canes extend outwardly from the vine trunk and are supported by the trellis wire such that the fruit clusters will be at or along the trellis wire. The pneumatic raisin harvester has a head support assembly with a support structure that is mounted to or on the tractor. In the preferred embodiment, the support structure includes a generally vertical mast member pivotally connected to a support arm having a first end positioned generally at the tractor and a second end that extends outwardly from the tractor to support, in a suspended manner, a harvesting head configured to dislodge the DOV raisins from the vines. In the preferred embodiment, the support arm can raise and lower the harvesting head and pivot the harvesting head from one side of the tractor to the other. The harvesting head is configured with a head enclosure that is configured to substantially straddle the trellis wire and the support stakes as the tractor moves along between the rows of vines. The head enclosure has a crop separating mechanism disposed therein for separating the raisins from the plurality of vines and a discharge opening, preferably located at a bottom edge thereof, that is configured to discharge raisins from the harvesting head. In the preferred embodiment, the crop separating mechanism includes a plurality of beater rods that are flexible or flexibly disposed inside the head enclosure. Also in the preferred embodiment, the bottom side of the harvesting head is angled to facilitate movement of the raisins to the head discharge opening and it includes one or more bottom sealing members, such as brush or brush-like members, that are configured to allow passage of the support stakes through the head enclosure while substantially preventing passage of raisins through the bottom side of the harvesting head.

The preferred raisin harvester also includes a pneumatic conveying system, supported on the tractor, that has a blower configured to discharge high velocity air through one or more air tubes that are connected to the blower. A venturi type of inlet interconnects with the air tubes downstream of the source of air (i.e., the blower). A raisin collecting system, which includes a conveyor connected to the tractor and positioned below the harvesting head discharge opening, is configured to receive the raisins discharged from the harvesting head and then convey the raisins to the inlet where the raisins are received into the air tubes. In the preferred embodiment, the conveyor is configured to pivot from one side of the tractor to the other with the harvesting head. Also in the preferred embodiment, a leaf blower mechanism is disposed above the conveyor to remove leaves and other lightweight debris from the conveyor. The high-velocity air from the blower pneumatically transports the raisins rearward of the tractor through the air tubes to the raisin bins on the bin trailer towed behind the field vehicle. In the preferred embodiment, the air tubes include a discharge tube attached to the tractor and a receiver tube attached to the bin trailer above the raisin bins, with the receiver tube configured to discharge raisins into each of the raisin bins. Also in the preferred embodiment, the discharge tube is in spaced apart relation to the receiver tube so the tractor can twist, turn or otherwise move relative to the bin trailer. Preferably, the receiver tube has an enlarged inlet, such as a bell mouth receiver, that is configured to receive raisins blown from the discharge tube into the receiver tube. The receiver tube is also provided with one or more deflector plates disposed therein that are configured to direct the blown raisins through a slotted opening in the receiver tube to the raisin bins on the bin trailer.

Accordingly, the primary objective of the present invention is to provide a pneumatic raisin harvester that provides the advantages discussed above and overcomes the disadvantages and limitations associated with presently available harvesters for harvesting raisins.

It is also an important objective of the present invention to provide an effective and economic harvester and harvesting system for harvesting DOV raisins.

It is also an important objective of the present invention to provide a raisin harvester that comprises various raisin harvesting mechanical components that are configured to be mounted to commonly available farm equipment, such as a tractor or other such vehicles, or which can be configured together as an integral harvesting unit.

It is also an important objective of the present invention to provide a raisin harvesting apparatus and system that reduces the dependancy on labor intensive methods of harvesting raisins, facilitates DOV raisin production (which reduces the potential of weather-related problems during drying of the raisins and eliminates the problems associated with dirt and sand becoming embedded in the raisins) and eliminates the need for special soil preparation.

The above and other objectives of the present invention will be explained in greater detail by reference to the attached figures and the description of the preferred embodiment which follows. As set forth herein, the present invention resides in the novel features of form, construction, mode of operation and/or combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a side view of a pneumatic raisin harvester configured according to a preferred embodiment of the present invention being towed behind a typical tractor;

FIG. 2 is a front view of the pneumatic raisin harvester of the present invention shown in FIG. 1, without the front pneumatic tube, shown in use with a specially configured raisin trellis system;

FIG. 3 is a top view of the pneumatic raisin harvester of the present invention shown in FIG. 1;

FIG. 4 is a side cross-sectional view of a preferred embodiment of a pneumatic receiving tube for use with the pneumatic raisin harvester of the present invention; and

FIG. 5 is a section view of the receiver tube taken through the Section 5-5 of FIG. 4 showing the discharge slot therein.

### DETAILED DESCRIPTION OF THE PREFERRED EMBODIMENTS

With reference to the figures where like elements have been given like numerical designations to facilitate the reader's understanding of the present invention, and particularly with reference to the embodiments of the pneumatic raisin harvester of the present invention illustrated in the figures, a preferred embodiment of the present invention is set forth below. The enclosed description and drawings are merely illustrative of one or more preferred embodiments and represent several different ways of configuring the present invention. Although specific components, materials, configurations and uses of the present invention are illustrated and set forth in this disclosure, those skilled in the art will readily understand that a number of variations to the components and to the configuration of those components described herein and in the accompanying figures can be made without changing the scope and function of the invention set forth herein.

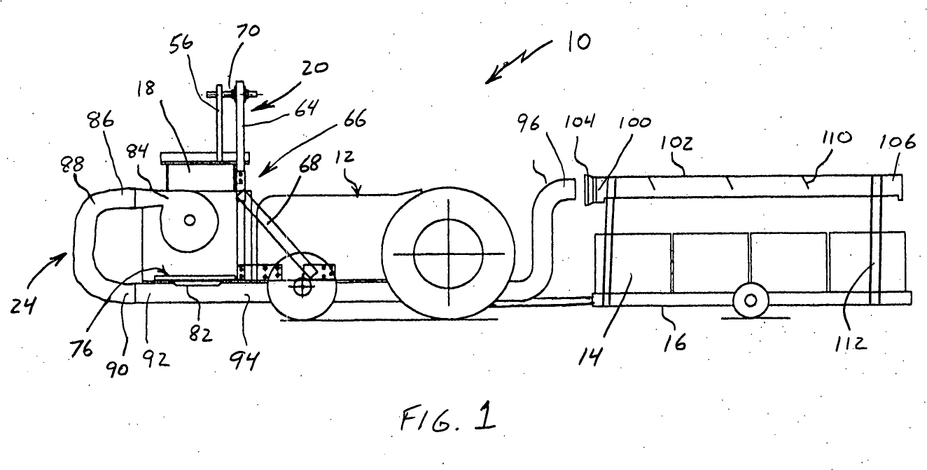

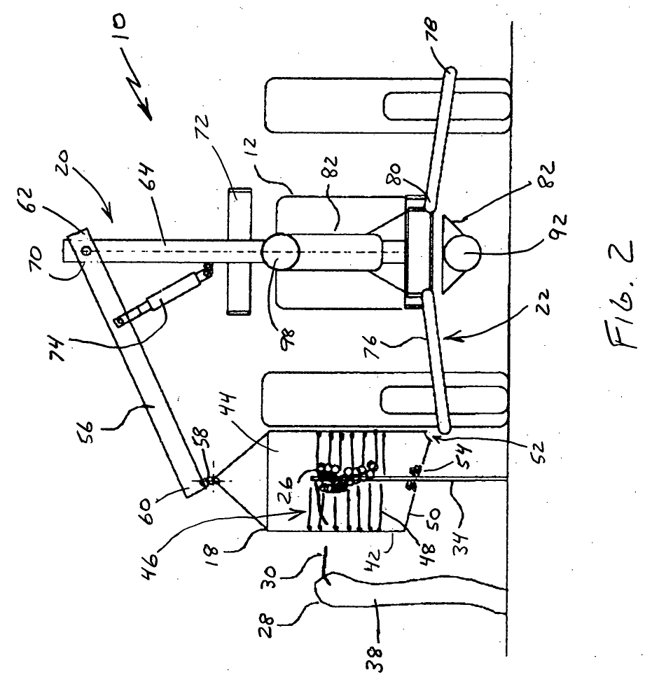

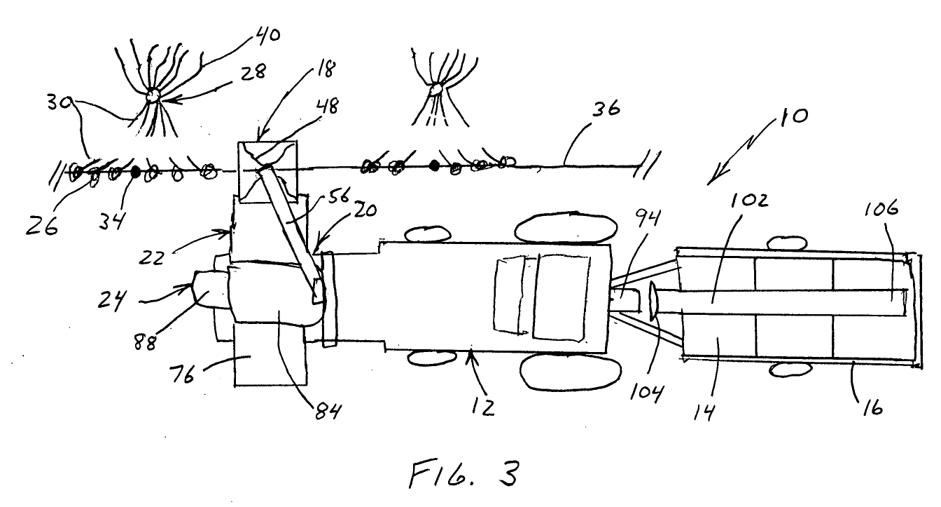

A pneumatic raisin harvester that is manufactured out of the components and configured pursuant to the harvester of the present invention is shown generally as 10 in the figures. As shown in FIGS. 1 and 2, pneumatic raisin harvester 10 is used in conjunction with a typical vineyard/field vehicle, such as tractor 12, or other suitable towing apparatus, to harvest DOV raisins 14 supported on trellis structure 16 (shown in FIGS. 2 and 3), which is described in more detail below. In one of the preferred embodiments of the present invention, pneumatic raisin harvester 10 is provided as an apparatus that mounts to tractor 12 to discharge raisins into one or more raisin bins 14 carried on a typical bin trailer 16 towed behind tractor 12, all of which may already be owned or available to the raisin grower, to form harvester 10. In an alternative embodiment, pneumatic raisin harvester 10 is sold as a prefabricated unit (i.e., fixedly attached or integral) with a vineyard moveable vehicle 12 configured to tow bin trailer 16 having one or more raisin bins 14 thereon. As is generally widely known in the art, bin trailers 16 are configured to removably support and carry one or more raisin bins 14. Once full of raisins, the raisin bins 14 are removed from bin trailer 16 and transported to a packing house or other raisin processing facility.

Whether sold as a mount-on apparatus or as a unit with tractor 12, pneumatic raisin harvester 10 of the present invention generally comprises harvesting head 18, head support assembly 20, raisin collecting system 22 and pneumatic conveying system 24. As explained in more detail below and best shown in FIG. 2, harvesting head 18 is configured to dislodge DOV raisins 26 from the plurality of vines 28 having fruiting canes 30 supported by a specially adapted trellis system 32 and then deposit the separated raisins (not shown) on raisin collecting system 22. Pneumatic conveying system 24 pneumatically transmits the raisins to the raisin bins 14 carried by bin trailer 16. As shown in FIGS. 2 and 3, the preferred trellis system 32 for use with the pneumatic raisin harvester 10 of the present invention utilizes a plurality of support stakes 34, such as a metal vineyard stake, and a trellis wire 36 that are spaced apart from the vine trunk 38 of vines 28 to allow harvesting head 18 to function as described below. In one embodiment, support stake 34 is spaced approximately twenty-two inches from vine trunk 38 and the vine 28 is trained such that, in an alternating bearing vine system, the present year's fruiting canes 30 are tied to and supported by trellis wire 36 and the renewal canes 40, which are the following year's fruiting canes, are directed generally away from trellis system 32. In this manner, harvesting head 18 of pneumatic raisin harvester 10 can be utilized to dislodge the DOV raisins 26 from fruiting canes 30. As known to those skilled in the art, trellis wire 36 is used to both support and interconnect support stakes 34 and support fruiting canes 30 having DOV raisins 26. As is also well known to those skilled in the art, DOV raisins 26 are established by cutting fruiting canes 30 at the appropriate time in the growing season (i.e., typically approximately five weeks before the desired harvesting) to begin the dehydration process. After the fruiting canes 30 are shear cut, the grapes are left thereon, supported by trellis wire 36 of trellis system 32, for the appropriate amount of time to establish DOV raisins 26 to be harvested by the pneumatic raisin harvester 10.

Harvesting head 18 is configured to extend outwardly from the side of tractor 12 and be supported by head support assembly 20 attached thereto such that it generally follows trellis wire 36 as tractor 12 moves along the area between rows of vines 28. In the preferred embodiment, harvesting head 18 comprises a head frame structure 42 substantially forming a head enclosure 44 configured to straddle trellis wire 36 and the portion of fruiting cane 30 on which the clusters of DOV raisins 26 are attached, as best shown in FIGS. 2 and 3. Disposed inside head enclosure 44 and, preferably, attached to head frame structure 42, is a crop separating mechanism 46 which is configured to dislodge the DOV raisins 26 from the fruiting canes 30 as the harvesting head 18 moves along trellis wire 36 by the movement of tractor 12. In the preferred embodiment, crop separating mechanism 46 comprises a plurality of beater rods 48, various configurations of which are well known in the art, flexibly disposed inside head enclosure 44 and configured to extend inwardly from the sides of head frame structure 42. Preferably, beater rods 48 are driven by a hydraulic motor (not shown) that oscillates, shakes, rotates or otherwise moves the beater rods 48 inside head enclosure 44. If desired, the hydraulic motor can be operatively connected to an oscillating or other drive mechanism, such as a rotating cam (also not shown), to produce a rapid stroke to oscillate or flex beater rods 48 so as to obtain a rapid whipping action whereby beater rods 48, which extend into trellis wires 36 to contact the leaves and stems in the canopy of the fruiting canes 30 supported on trellis wires 36, contacts and shakes the canopy to dislodge the DOV raisins 26. In the preferred embodiment, the oscillating speed or frequency of crop separating mechanism 46 is adjustable to allow the user to vary the oscillation or other movement thereof as necessary or desired to better dislodge DOV raisins 26. As known to those skilled in the art, various field factors, including air humidity, raisin moisture content and the vine moisture content, can affect the ability to dislodge DOV raisins 26 from fruiting canes 30. To provide the necessary contact action, it is preferred that beater rods 48 should be configured to be flexible (i.e., oscillate) and placed in a multitude of rows. In one configuration, pneumatic raisin harvester 10 utilizes approximately seven curved beater rods 48 on each side of head enclosure 44 and beater rods 48 comprise a rubber coated metal rods that are pivotally attached (so as to oscillate) at each end of rods 48 to head frame structure 42. Beater rods 48 can be made out of fiberglass, composites, polymers or other materials that provide sufficient flexibility and are able to withstand repeated contact against the canopy of fruiting canes 30 and trellis wires 36. Also, the preferred embodiment has beater rods 48 removably attached to head frame structure 42 so they can be replaced as needed. Other types of crop separating mechanisms 46, including the various types of mechanisms disclosed in the prior art referenced above and those which are otherwise known in the art, are also suitable for the pneumatic raisin harvester 10 of the present invention.

Head frame structure 42 should be sized and configured to substantially encompass the fruiting canopy supporting the DOV raisins 26. In one configuration, harvesting head 18 is four feet across, eighteen inches long (direction of travel) and three feet high. The sides parallel to tractor 12 are substantially closed to prevent loss of raisins after they become dislodged from fruiting canes 30. Although the ends (direction of travel) of harvesting head 18 can be substantially open, in the preferred embodiment a shroud-type of cover, such as a plurality of rubber flaps, is used at both ends to better contain the dislodged raisins inside harvesting head 18. Having both ends generally open (i.e., with or without the shroud) allows the harvesting head 18 to be bi-directional so pneumatic raisin harvester 10 can turn at the end of a row of vines 28 and go along the adjacent row. In the preferred embodiment, the bottom side 50 of harvesting head 18 is angled, as shown in FIG. 2, to facilitate movement of the raisins to the head discharge opening 52 at the bottom edge nearest tractor 12 to allow the raisins to drop onto raisin collecting system 22 and be pneumatically transferred to raisin bins 14, as described below. Preferably, the angle of bottom side 50 is greater than the angle of repose for the raisins. Head discharge opening 52 can be disposed partially or completely along the bottom edge of head frame structure 42. As will be made clear below, the length of head discharge opening 52 should be cooperatively sized such that the raisins displaced therefrom do not, in any substantial quantity, fall on the ground below tractor 12. To facilitate receiving support stake 34 inside head enclosure 44 and prevent raisins dropping out bottom side 50, head frame structure 42 comprises a loosely configured bottom sealing mechanism 54, such as a pair of brush or brush-type members on either side of the opening in bottom side 50 where support stake 34 is received. In one embodiment, sealing mechanisms 54 include springs or other flexing members to allow opening and closing thereof as necessary to allow support stakes 34 to pass yet prevent loss of raisins through the bottom side 50 of harvesting head 18 between adjacent support stakes 34 or at the end of the row. Bottom sealing mechanisms 54 should be configured to allow the relatively easy entry of support stake 34, yet be suitable for substantially straddling support stake 34 and preventing raisins from falling through bottom side 50 and onto the ground where they are typically lost.

In the preferred embodiment, as best shown in FIG. 2, harvesting head 18 is supported, in an outwardly extending, generally suspended manner, by support arm 56 of head support assembly 20. In one embodiment, harvesting head 18 is suspended with one or more chain members 58 at the first end 60 of support arm 56 such that harvesting head 18 is free to partially swing left and right to allow for non-perfect linear alignment of support stakes 34 and movement of tractor 12. The second end 62 of support arm 56 is pivotally attached to mast member 64, which extends substantially upright from support structure 66 having one or more support members 68 attached to tractor 12, as best shown in FIGS. 1 and 2. As shown in FIG. 1, support structure 66 can be bolted to tractor 12. Alternatively, support structure 66 can be attached to tractor 12 by welding, rivets, screws or by using a variety of other connecting mechanisms. A suitable bearing mechanism 70 can be utilized to allow support arm 56 to raise and lower harvesting head 18 for optimum placement of harvesting head 18 relative to the fruited canopy around DOV raisins 26 and to allow the user to pivot harvesting head 18 from one side of the tractor 12 to the other in order to permit the efficient movement up one row and then the adjacent row of vines 28 (i.e., to avoid having to “deadhead” along an adjacent row). One or more cross arms 72, which connect to tractor 12, can be utilized to help support mast member 64 in an upright position and otherwise strengthen support structure 66. To facilitate the upward and downward movement of support member 56 and allow the user to move harvesting head 18 from one side of tractor 12 to the other, the preferred embodiment includes an adjusting mechanism, such as hydraulic cylinder 74 best shown in FIG. 2, operatively connected to a hydraulic system (not shown). In the preferred embodiment, adjusting mechanism 74 is configured to sufficiently raise harvesting head 18 above the level of vines 28 when it is desired for pneumatic harvester 10 to exit the vineyard and to allow the user to operate the system to move support arm 56 from inside the cab of tractor 12. As stated above, the components described herein can be sold or otherwise provided as add-on equipment for tractor 12 or other field equipment or sold as an integral unit with tractor 12 or other field equipment.

Once the DOV raisins 26 are dislodged from fruiting canes 30 and fall through harvesting head 18, they are deposited onto mechanical belt conveyor 76 of raisin collecting system 22 for transport to, ultimately, raisin bins 14. As best shown in FIGS. 2 and 3, in one embodiment each side of tractor 12 is provided with conveyor 76 so that raisins can be harvested from either side thereof. In a preferred embodiment, pneumatic raisin harvester 10 has a single conveyor 76 that is configured to pivot from one side of tractor 12 to the other with the pivoting of harvesting head 18 described above. In either configuration, first end 78 of conveyor 76 extends outwardly from tractor 12 to be disposed at least partially under head discharge opening 52 of harvesting head 18 such that when raisins are discharged therefrom they will fall on conveyor 76 and be transferred toward the second end 80 of conveyor 76 located at tractor 12. To help maintain the position of first end 78 of conveyor 76 relative to head discharge opening 52 of harvesting head 18, one or more interconnecting chains (not shown) are utilized to connect first end 78 of conveyor and harvesting head 18. Positioned below the second end 80 of conveyor 76, and configured to receive raisins therefrom, is a generally funnel-shaped, venturi section inlet 82 that is configured to transmit the raisins to pneumatic conveying system 24, as explained in more detail below. As known to those skilled in the art, conveyor 76 can be hydraulically driven and be provided with side members (not shown) to prevent raisins from falling off conveyor 76 and on to the ground. In the preferred embodiment, a leaf blower mechanism (not shown), the use of which is known in the art, is positioned above conveyor 76 to suction and then discharge leaves and other lightweight debris from conveyor 76 to reduce the amount of such debris collected in raisin bins 14.

In one embodiment, best shown in FIG. 1, the pneumatic conveying system 24 of the pneumatic raisin harvester 10 of the present comprises a blower 84, or other mechanism for supplying high velocity air into pneumatic conveying system 24, that is configured to discharge pressurized air into the first end 86 of flexible air tube or duct 88 that connects at its second end 90 to the first end 92 of a rigid discharge tube 94 having second end 96 at the rear of tractor 12. Venturi section inlet 82 is configured to draw raisins into discharge tube 94 such that the raisins will be pneumatically transmitted through discharge tube 94 to the second end 96 thereof. Blower 84 can be one of numerous standard, hydraulically driven commercial blowers suitable for delivering a sufficient quantity of pressurized air so as to transmit the raisins through discharge tube 94. FIG. 2 shows front view of the pneumatic raisin harvester 10 of the present invention with the flexible air tube 88 removed therefrom to show the blower discharge outlet 98 that connects, as shown in FIG. 1, to the first end 86 of flexible air tube 88. Although the figures and discussion above references a flexible tube 88 and a separate discharge tube 94, it will be readily apparent to those skilled in the art that the invention is not so limited. If desired, a single length of discharge tube 94, whether flexible or rigid, can connect to blower outlet 98 and extend to where second end 96 of discharge tube 94 is positioned.

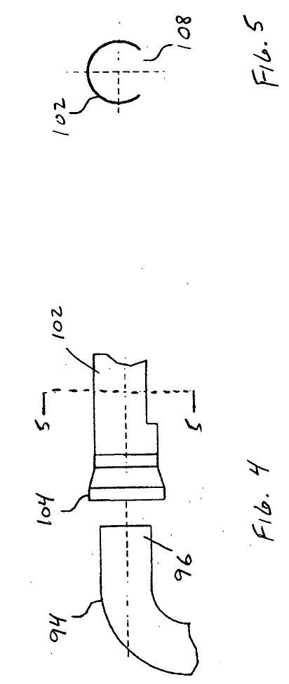

As shown in FIG. 1, raisins discharged from second end 96 of discharge tube 94 are directed into the first end 100 of receiver tube 102 for deposit into raisin bins 14 carried on bin trailer 16. In the preferred embodiment, first end 100 of receiver tube 102 has an enlarged inlet, such as bell mouth receiver 104 (shown in FIGS. 1 and 4), and the second end 106 of receiver tube 102 is closed. As best shown in FIG. 5, the bottom side of receiver tube 102 is provided with a slotted section 108 to facilitate the raisins being discharged into raisin bins 14. To further facilitate the discharge of the raisins into raisin bins 14, receiver tube 102 of the preferred embodiment is provided with one or more operative deflector plates 110 that are configured, as known to those skilled in the art, to be manually or mechanically controlled so as to fill the first raisin bin 14 and then subsequent raisin bins 14. In the preferred embodiment, bin trailer 16 is provided with a plurality of generally vertical support members 112 attached thereto that have a horizontal member (not shown) located at or near the top thereof with brackets (also not shown) configured to support receiver tube 102 above raisin bins 14, four which are shown, on bin trailer 16. Other types of configurations of supports can be utilized to support receiver tube 102 above raisin bins 14. In the preferred embodiment, the second end 96 of discharge tube 94 is in spaced apart relation to bell mouth receiver 104, which is configured to receive raisins blown across the gap, so that tractor 12 can turn corners, flex or twist relative to bin trailer 16 as it moves through the vineyard. In another configuration, a flexible connector (not shown) interconnects second end 96 of discharge tube 94 and first end 100 of receiver tube 102 such that the desired turning capability is allowed. Other types of configurations can also be utilized to flexibly interconnect discharge tube 94 and receiver tube 102.

In use, the vineyard is configured with support stakes 34 in spaced apart relation to vine trunks 38 and the fruiting canes 30 are trained to grow along trellis wire 36. Once the raisin grapes have grown the appropriate amount, the fruiting cane 30 is shear cut so that the raisin grapes will dehydrate into DOV raisins 26. When it is time to harvest the DOV raisins 26, the user will align harvesting head 18 such that bottom sealing mechanism 54 (i.e., the brush members) will be appropriately aligned with support stakes 34 and trellis wire 36 so that the fruiting canopy having DOV raisins 26 will enter into head enclosure 44 where the crop separating mechanism 46, such as beater rods 48, will dislodge the DOV raisins 26 from the fruiting canes 30. Once dislodged, the raisins will fall to the bottom side 50 of harvesting head 18 and move toward head discharge opening 52 where they will be discharged onto the first end 78 of conveyor 76 and then be conveyed to the second end 80 thereof for depositing into the venturi section inlet 82. Pressurized air from blower 84 traveling through flexible tube 88 and discharge tube 94 will transport the raisins from venturi section inlet 82 to the second end 96 of discharge tube 94. From the second end 96 of discharge tube 94, the raisins are blown across to bell mouth receiver 104 and into receiver tube 102. The deflector plates 110 in receiver 102 are operated to selectively discharge the raisins through slotted section 108 into raisin bins 14 on bin trailer 16. The pneumatic raisin harvester 10 can utilize the hydraulic system of tractor 12 to operate the hydraulic components thereof. Alternatively, a separate hydraulic system can be included with the components of pneumatic raisin harvester 10. As stated above, the pneumatic raisin harvester 10 of the present invention can be provided as an apparatus that attaches, either removably or fixedly, to a tractor 12 already owned or available to the user, or pneumatic raisin harvester 10 can be provided as a pre-manufactured unit already affixed to a tractor 10 or other field vehicle. In either type of configuration, the pneumatic raisin harvester 10 of the present invention can substantially reduce the amount of labor and costs associated with harvesting DOV raisins 26 relative to presently available systems without the need for expensive upgrade or retrofitting of the vineyard or capital investment in expensive harvesting equipment.

While there are shown and described herein certain specific alternative forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to the dimensional relationships set forth herein and modifications in assembly, materials, size, shape, and use. For instance, there are numerous components described herein that can be replaced with equivalent functioning components to accomplish the objectives of the present invention.

1. A pneumatic raisin harvester for use with a field vehicle towing a bin trailer having one or more raisin bins thereon to harvest DOV raisins from a plurality of vines supported on a trellis wire interconnecting a plurality of support stakes, said pneumatic raisin harvester comprising:
a head support assembly having a support structure mounted to the field vehicle, said support structure comprising a support arm having a first end generally at the field vehicle and a second end extending outwardly from the field vehicle;
a harvesting head at said second end of said support arm, said harvesting head having a head enclosure configured to substantially straddle the trellis wire and the plurality of support stakes, said head enclosure having a discharge opening configured to discharge raisins from said harvesting head;
crop separating means disposed in said head enclosure for separating the raisins from the plurality of vines;
a pneumatic conveying system having a blower supported on the field vehicle and configured to discharge high velocity air through one or more air tubes connected to said blower;
an inlet into one of said one or more air tubes; and
a raisin collecting system having a conveyor supported on the field vehicle and configured to receive the raisins from said head discharge opening and then convey the raisins to said inlet and into said one or more air tubes so as to facilitate pneumatic transport of the raisins rearward of the field vehicle through said one or more air tubes to one of the one or more raisin bins on the bin trailer towed behind the field vehicle.

2. The pneumatic raisin harvester according to claim 1, wherein said support structure further comprises a mast member extending substantially upright from said field vehicle and interconnecting said field vehicle to said support arm.

3. The pneumatic raisin harvester according to claim 2, wherein said support arm is pivotally attached to said mast member and configured to raise and lower said harvesting head.

4. The pneumatic raisin harvester according to claim 1, wherein one or more fruiting canes of each of the one or more vines are trained to extend from a trunk of the vine toward the trellis wire and be supported thereon.

5. The pneumatic raisin harvester according to claim 1, wherein said crop separating means comprises a plurality of beater rods.

6. The pneumatic raisin harvester according to claim 5, wherein said beater rods are hydraulically activated and flexibly mounted to a head frame structure forming said head enclosure.

7. The pneumatic raisin harvester according to claim 1, wherein said harvesting head comprises a bottom side having one or more bottom sealing members configured to allow passage of the support stakes through said head enclosure while substantially preventing passage of raisins through said bottom side.

8. The pneumatic raisin harvester according to claim 7, wherein said bottom side is angled to facilitate movement of the raisins to said head discharge opening.

9. The pneumatic raisin harvester according to claim 1, wherein said one or more air tubes comprises a discharge tube attached to the field vehicle and a receiver tube attached to the bin trailer above the one or more raisin bins, said receiver tube configured to discharge raisins into each of the one or more raisin bins.

10. The pneumatic raisin harvester according to claim 9, wherein said discharge tube is in spaced apart relation to said receiver tube, said receiver tube having an enlarged inlet configured to receive raisins blown from said discharge tube into said receiver tube.

11. The pneumatic raisin harvester according to claim 9, wherein said receiver tube has one or more selector plates therein to selectively discharge raisins through a slotted section of said receiver tube into one of the one or more raisin bins.

12. The pneumatic raisin harvester according to claim 1, wherein said one or more air tubes are configured to allow movement of the field vehicle relative to the bin trailer.

13. The pneumatic raisin harvester according to claim 1, wherein said inlet comprises a venturi section.

14. A pneumatic raisin harvester for use with a field vehicle towing a bin trailer having one or more raisin bins thereon to harvest DOV raisins from a plurality of vines supported on a trellis wire interconnecting a plurality of support stakes, said pneumatic raisin harvester comprising:
a head support assembly having a support structure mounted to the field vehicle, said support structure comprising a support arm having a first end generally at the field vehicle and a second end extending outwardly from the field vehicle;
a harvesting head suspended at said second end of said support arm, said harvesting head having a head enclosure configured to substantially straddle the trellis wire and the plurality of support stakes, said head enclosure having a discharge opening configured to discharge raisins from said harvesting head, said harvesting head having a bottom side with one or more bottom sealing members configured to allow passage of the support stakes through said head enclosure while substantially preventing passage of raisins through said bottom side, said bottom side being angled to facilitate movement of the raisins to said head discharge opening;
crop separating means disposed in said head enclosure for separating the raisins from the plurality of vines;
a pneumatic conveying system having a blower supported on the field vehicle and configured to discharge high velocity air through one or more air tubes connected to said blower;
an inlet into one of said one or more air tubes, said inlet comprising a venturi section; and
a raisin collecting system having a conveyor supported on the field vehicle and configured to receive the raisins from said head discharge opening and then convey the raisins to said inlet and into said one or more air tubes so as to facilitate pneumatic transport of the raisins rearward of the field vehicle through said one or more air tubes to one of the one or more raisin bins on the bin trailer towed behind the field vehicle.

15. The pneumatic raisin harvester according to claim 14, wherein said crop separating means comprises a plurality of beater rods.

16. The pneumatic raisin harvester according to claim 14, wherein said one or more air tubes comprises a discharge tube attached to the field vehicle and a receiver tube attached to the bin trailer above the one or more raisin bins, said receiver tube configured to discharge raisins into each of the one or more raisin bins.

17. The pneumatic raisin harvester according to claim 16, wherein said discharge tube is in spaced apart relation to said receiver tube, said receiver tube having an enlarged inlet configured to receive raisins blown from said discharge tube into said receiver tube.

18. A pneumatic raisin harvester for harvesting DOV raisins from a plurality of vines supported on a trellis wire interconnecting a plurality of support stakes, said pneumatic raisin harvester comprising:
a head support assembly having an elongated support arm with a first end and a second end, said second end of said support arm generally extending outwardly from said head support assembly;
a harvesting head at said second end of said support arm, said harvesting head having a head enclosure configured to substantially straddle the trellis wire and the plurality of support stakes, said head enclosure having a discharge opening configured to discharge raisins from said harvesting head;
crop separating means disposed in said head enclosure for separating the raisins from the plurality of vines;
a pneumatic conveying system connected to said head support assembly, said pneumatic conveying system having a blower configured to discharge high velocity air through one or more air tubes connected to said blower;
an venturi inlet into one of said one or more air tubes; and
a raisin collecting system connected to said head support assembly, said raisin collecting system having a conveyor configured to receive the raisins from said head discharge opening and then convey the raisins to said venturi inlet and into said one or more air tubes so as to pneumatically transport the raisins through said one or more air tubes into one or more raisin bins.

19. The pneumatic raisin harvester according to claim 18, wherein said harvesting head is generally suspended at said second end of said support arm.

20. The pneumatic raisin harvester according to claim 18, wherein said crop separating means comprises a plurality of beater rods.
